(19) United States
(12) Patent Application Publication
(10) Pub. No.: US 2025/0329962 A1
(43) Pub. Date: Oct. 23, 2025

(54) FEMALE CONNECTOR AND ELECTRICAL CONNECTOR

(71) Applicant: Luxshare Precision Industry Company Limited, SHENZHEN (CN)

(72) Inventors: Yingbin PU, SHENZHEN (CN); Xiangpiao YANG, SHENZHEN (CN)

(73) Assignee: Luxshare Precision Industry Company Limited, SHENZHEN (CN)

(21) Appl. No.: 18/768,527

(22) Filed: Jul. 10, 2024

(30) Foreign Application Priority Data
Apr. 17, 2024 (CN) 202410465322.7

(51) Int. Cl. H01R 13/631; H01R 12/71; H01R 12/73

(52) U.S. Cl. CPC H01R 13/631; H01R 12/716; H01R 12/73

(57) ABSTRACT

A female connector includes a base and a conductive terminal. The base is formed with a plug slot, a first plug hole, and an auxiliary slot. A male connector is configured to be plugged in the plug slot. The first plug hole communicates with the plug slot and the auxiliary slot. The conductive terminal includes a terminal body and a limit structure. The terminal body is configured to be plugged through the first plug hole. One end of the terminal body has a contact portion located in the plug slot. The other end of the terminal body is connected to the limit structure limited in the auxiliary slot.

### CROSS-REFERENCE TO RELATED APPLICATION(S)

This application claims the priority to Chinese Patent Application No. CN202410465322.7, filed on Apr. 17, 2024, the disclosure of which is incorporated herein by reference in its entirety.

### TECHNICAL FIELD

The present application relates to the field of connector technology and, in particular, to a female connector and an electrical connector.

### BACKGROUND

An electrical connector is also commonly referred to as a circuit connector or an electronic connector and may be configured to bridge two electrical components on a circuit, so that a current or a signal may flow from one electrical component to another electrical component. Since the electrical connector is easy to be made into a standardized element and has high electrical connection reliability, the electrical connector is especially suitable for modular elements.

In the related art, an electrical connector includes a conductive terminal, an internal insulation block fixed outside the conductive terminal, and an external insulation block cladding outside the internal insulation block. The internal insulation block is connected to the external insulation block, so that the conductive terminal, the internal insulation block, and the external insulation block are connected and integrated. It can be seen that in the related art, the assembly and fixation of the conductive terminal need to be implemented by using an accessory (that is, the internal insulation block). As a result, the overall size of the electrical connector is relatively large and cannot be applied to an electronic product having high size requirements.

Thus, a small-sized socket and electrical connector are urgently needed.

### SUMMARY

One object of the present application is to provide a female connector which has a relatively small overall size and wide application range.

As conceived previously, the following describes the solution of the present application.

The female connector includes a base and a conductive terminal.

The base is formed with a plug slot, a first plug hole, and an auxiliary slot. A male connector is configured to be plugged in the plug slot. The first plug hole communicates with the plug slot and the auxiliary slot.

The conductive terminal includes a terminal body and a limit structure. The terminal body is configured to be plugged through the first plug hole. One end of the terminal body has a contact portion located in the plug slot. The other end of the terminal body is connected to the limit structure limited in the auxiliary slot.

Optionally, the female connector also includes an engagement holder and a second plug hole formed in the base. One end of the engagement holder is limited in the second plug hole, and the other end of the engagement holder is configured to engage and cooperate with the male connector.

Optionally, the engagement holder is a grounding terminal.

Optionally, two engagement holders and two second plug holes are correspondingly disposed. One end of each engagement holder is limited in a respective second plug hole. The base is formed with two receiving slots on opposite sides of the base in a first direction. The two engagement holders correspond to the two receiving slots in a one-to-one manner. The other end of the engagement holder is configured to enter a respective receiving slot under the compression of the male connector.

Optionally, the portion of the engagement holder located in the second plug hole is provided with a first barb, and the first barb is configured to abut against the hole wall of the second plug hole.

Optionally, the limit structure is provided with a second barb, and the second barb is configured to abut against the slot wall of the auxiliary slot.

Optionally, the other end of the terminal body connected to the limit structure is formed with a buffer slot, and the buffer slot is configured to enable one end of the terminal body having the contact portion to move in a second direction.

Optionally, multiple conductive terminals are disposed. One plug slot is disposed. Multiple first plug holes are disposed in one-to-one correspondence with multiple auxiliary slots. A contact portion at one end of each of multiple terminal bodies is located in one plug slot. The terminal bodies are correspondingly configured to be plugged through the first plug holes in a one-to-one manner. Limit structures are limited in the auxiliary slots in a one-to-one manner.

Optionally, multiple conductive terminals are disposed in the first direction at intervals. Each of the multiple auxiliary slots and a respective one of the multiple first plug holes are disposed in the second direction at intervals. The auxiliary slots are disposed on a side of the plug slot in a third direction. The first direction, the second direction, and the third direction are perpendicular to each other.

Optionally, in the first direction, two adjacent conductive terminals have a space of 0.8 mm to 2 mm.

The base has a length of 5 cm to 10 cm, a width of 5.5 cm to 10 cm, a height of 2 cm to 5 cm.

Another object of the present application is to provide an electrical connector which has a relatively small overall size.

As conceived previously, the following describes the solution of the present application.

The electrical connector includes the female connector as described above.

The present application has the beneficial effects below.

In the female connector and the electrical connector provided by the present application, the base is formed with the auxiliary slot. The conductive terminal includes a terminal body and a limit structure. The terminal body is configured to be plugged through the first plug hole. One end of the terminal body has the contact portion located in the plug slot. The other end of the terminal body is connected to the limit structure limited in the auxiliary slot. Indirectly, the terminal body is limited in the base, so that when the male connector is plugged in the plug slot, the terminal body may not move in a pluggable direction. Thus, it is ensured that the contact portion of the terminal body can smoothly contact the male connector, so that the conductive terminal is assembled and fixed on the base without contact with an internal insulation block. Instead, the conductive terminal is fixed in the base through its own structure, so that the overall size of the female connector may be relatively small, and the female connector can be applied to an electronic product having high size requirements and has a relatively large scope of application.

### BRIEF DESCRIPTION OF DRAWINGS

FIG. 1 is view one illustrating the structure of a female connector according to an embodiment of the present application.

FIG. 2 is view two illustrating the structure of a female connector according to an embodiment of the present application.

FIG. 3 is view one illustrating the structure of a base according to an embodiment of the present application.

FIG. 4 is view two illustrating the structure of a base according to an embodiment of the present application.

FIG. 5 is a view illustrating the structure of a conductive terminal according to an embodiment of the present application.

FIG. 6 is a view illustrating the structure of an engagement holder according to an embodiment of the present application.

FIG. 7 is sectional view one of a female connector according to an embodiment of the present application.

FIG. 8 is sectional view two of a female connector according to an embodiment of the present application.

FIG. 9 is a view illustrating the structure of an electrical connector according to an embodiment of the present application.

### REFERENCE LIST

100 base
110 plug slot
120 first plug hole
130 auxiliary slot
140 second plug hole
150 receiving slot
200 conductive terminal
210 terminal body
211 contact portion
212 buffer slot
220 limit structure
221 second barb
230 first connection end
300 engagement holder
310 first barb
320 engagement protrusion
330 second connection end
400 post
X first direction
Z second direction
Y third direction
10 male connector
101 engagement recess
20 circuit board

### DETAILED DESCRIPTION

To make solved problems, adopted technical solutions, and achieved effects of the present application more apparent, the technical solutions of the present application are described hereinafter in conjunction with drawings and embodiments. It is to be understood that the specific embodiments set forth below are intended to illustrate and not to limit the present application. In addition, it is to be noted that for ease of description, only part, instead of all, related to the present application is illustrated in the drawings.

It is to be noted that similar reference numerals and letters represent similar items in the drawings. Therefore, once an item is defined in one drawing, the item no longer needs to be defined and interpreted in the subsequent drawings.

In the description of the present application, unless otherwise expressly specified and limited, the term “connected to each other”, “connected” or “secured” is to be construed in a broad sense, for example, as securely connected, detachably connected or integrated; mechanically connected or electrically connected; directly connected to each other or indirectly connected to each other via an intermediary; or internal connection between two components or interaction relations between two components. For those of ordinary skill in the art, specific meanings of the preceding terms in the present application may be construed based on specific situations.

In the present application, unless otherwise expressly specified and limited, when a first feature is described as “above” or “below” a second feature, the first feature and the second feature may be in direct contact or be in contact via another feature between the two features. Moreover, when the first feature is described as “on”, “above”, or “over” the second feature, the first feature is right on, above, or over the second feature, the first feature is obliquely on, above, or over the second feature, or the first feature is simply at a higher level than the second feature. When the first feature is described as “under”, “below” or “underneath” the second feature, the first feature is right under, below or underneath the second feature, the first feature is obliquely under, below or underneath the second feature, or the first feature is simply at a lower level than the second feature. In the description of the embodiments, unless otherwise specified, “multiple” specifically refers to two or more.

In the description of the embodiments, the orientation or position relationships indicated by terms “above”, “below”, “right” and the like are based on the orientation or position relationships shown in the drawings. These orientations or position relationships are merely for ease of description and simplifying an operation and do not indicate or imply that the referred device or element has a specific orientation and is constructed and operated in a specific orientation. Thus, these orientations or position relationships are not to be construed as limiting the present application. In addition, the terms “first” and “second” are used only for distinguishing between descriptions and have no special meaning.

An embodiment provides a female connector which has a relatively small overall size and wide application range.

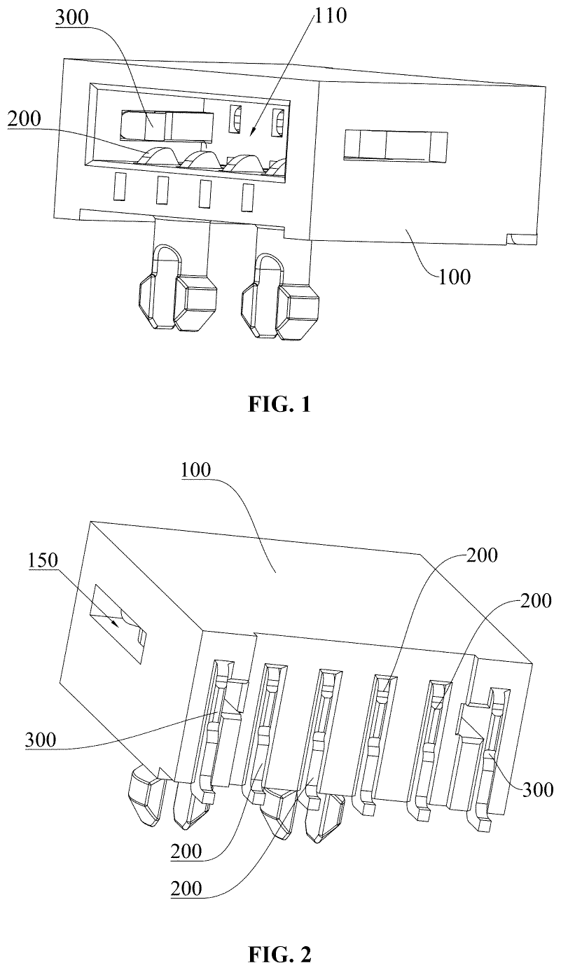

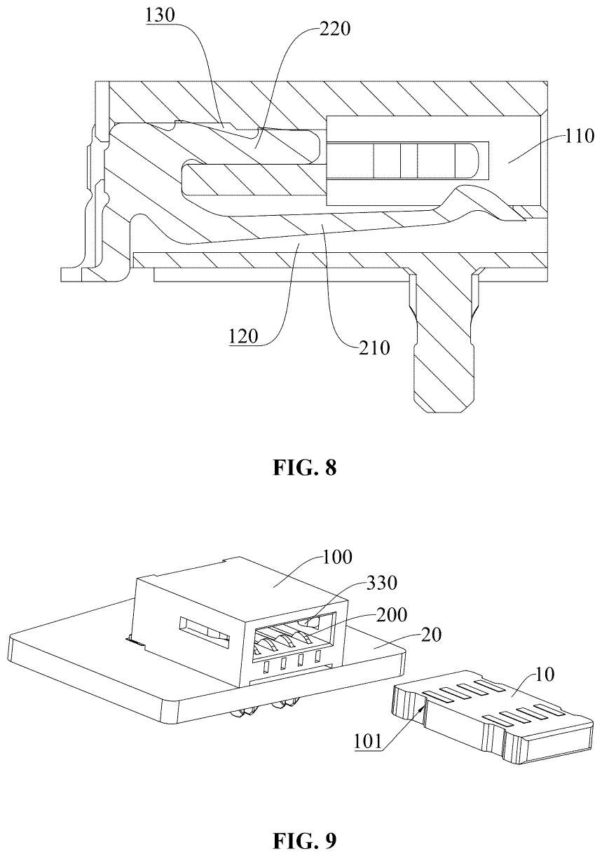

As shown in FIGS. 1 to 9, the female connector includes a base 100 and a conductive terminal 200. The base 100 is formed with a plug slot 110, a first plug hole 120, and an auxiliary slot 130. Specifically, the plug slot 110 is formed on the end surface of one end of the base 100, and a male connector 10 is configured to be plugged in the plug slot 110. The first plug hole 120 extends from an end surface of the other end of the base 100 in the length direction of the base 100, and the first plug hole 120 communicates with the plug slot 110 and the auxiliary slot 130. The auxiliary slot 130 is spaced apart from the plug slot 110, that is, the auxiliary slot 130 and the plug slot 110 do not directly communicate with each other.

The conductive terminal 200 includes a terminal body 210 and a limit structure 220. The terminal body 210 is configured to be plugged through the first plug hole 120. One end of the terminal body 210 has a contact portion 211 located in the plug slot 110. The contact portion 211 is configured to electrically contact the male connector 10. The other end of the terminal body 210 is connected to the limit structure 220 limited in the auxiliary slot 130, that is, the limit structure 220 and the terminal body 210 form a U-shaped structure, thereby allowing the conductive terminal 200 to be clamped in the base 100, thus securing the conductive terminal 200 in the base 100.

For the female connector provided in this embodiment, the base 100 is formed with the auxiliary slot 130. The conductive terminal 200 includes a terminal body 210 and a limit structure 220. The terminal body 210 is configured to be plugged through the first plug hole 120. One end of the terminal body 210 has a contact portion 211 located in the plug slot 110. The other end of the terminal body 210 is connected to the limit structure 220 limited in the auxiliary slot 130. In this case, the limitation of the terminal body 210 in the base 100 is indirectly achieved, this ensures that when the male connector 10 is plugged into the plug slot 110, the terminal body 210 may not move in an plugging and unplugging direction. Thus, it is ensured that the contact portion 211 of the terminal body 210 can smoothly contact the male connector 10, so that the conductive terminal 200 is assembled and fixed on the base 100 without contact with an internal insulation block. Instead, the conductive terminal 200 is fixed in the base 100 through its own structure, so that the overall size of the female connector may be relatively small, and the female connector can be applied to an electronic product having high size requirements and has a relatively large scope of application.

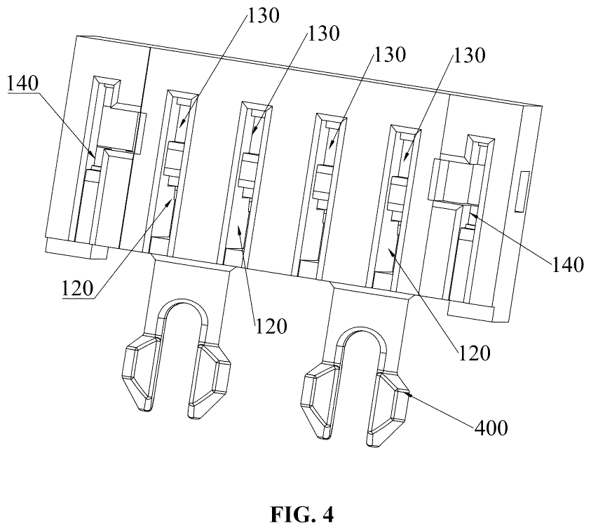

Optionally, as shown in FIG. 1 or FIG. 2, the female connector also includes an engagement holder 300. As shown in FIG. 4, the base 100 is also formed with a second plug hole 140. One end of the engagement holder 300 is limited in the second plug hole 140, so that the engagement holder 300 may not move in a pluggable direction. The other end of the engagement holder 300 is configured to engage and cooperate with the male connector 10 to improve the stability and reliability of the contact between the female connector and the male connector 10.

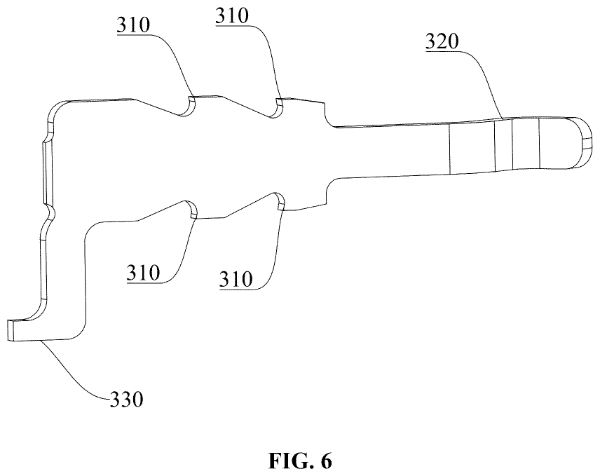

For example, as shown in FIG. 6, the other end of the engagement holder 300 is provided with an engagement protrusion 320. As shown in FIG. 9, the male connector 10 is formed with an engagement recess 101. The engagement protrusion 320 engages and cooperates with the engagement recess 101, so that the male connector 10 can be limited in the pluggable direction, and the contact portion 211 can stably contact the male connector 10.

In some optional embodiments, the engagement holder 300 is a grounding terminal. That is, when an electronic product has a high current, the engagement holder 300 may be used as a power grounding terminal, so that the female connector may be configured to transmit a high current, thereby further improving the scope of application of the female connector and an electronic product using the female connector. For example, the material of the engagement holder 300 is a copper alloy and has a relatively large signal transmission capability.

Optionally, two engagement holders 300 and two second plug holes 140 are correspondingly disposed. The two engagement holders 300 are disposed opposite to each other in a first direction X. One end of each engagement holder 300 is limited in a respective second plug hole 140. The two engagement holders 300 are configured to engage with and stop the male connector 10 in the first direction X, thereby further improving the stability of the connection between the male connector 10 and the female connector. For example, one of the two engagement holders 300 is located on one side of the plug slot 110 in the first direction X, and the other of the two engagement holders 300 is located on the other side of the plug slot 110 in the first direction X.

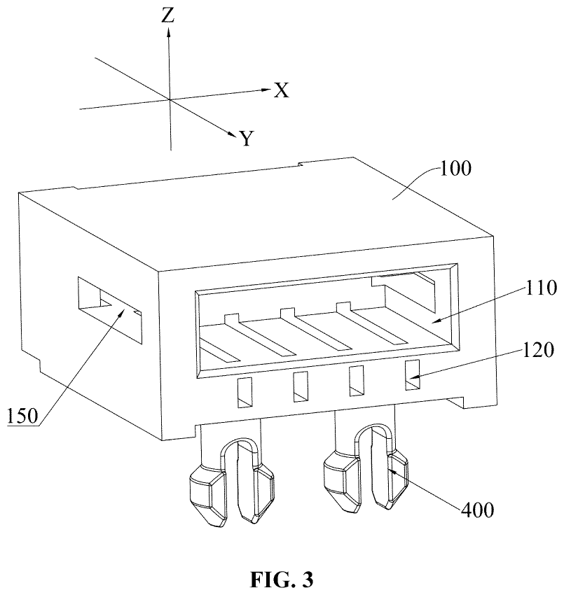

Further, optionally, as shown in FIG. 3, the base 100 is formed with two receiving slots 150 on opposite sides of the base 100 in the first direction X. The receiving slot 150 extends in the first direction X to communicate with the plug slot 110. The two engagement holders 300 correspond to the two receiving slots 150 in a one-to-one manner. The other end of each engagement holder 300 is configured to enter a respective receiving slot 150 under the compression of the male connector 10 to form temporary avoidance, thereby facilitating plugging of the male connector 10. In this embodiment, one end of the engagement holder 300 is fixed, and the other end of the engagement holder 300 can move in the first direction X. That is, the engagement holder 300 can undergo elastic deformation, so that the engagement protrusion 320 engages and cooperates with the engagement recess 101.

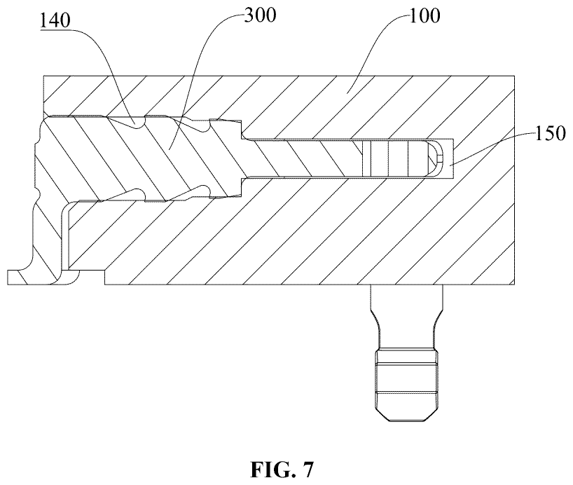

Optionally, as shown in FIGS. 6 and 7, the portion of the engagement holder 300 located in the second plug hole 140 is provided with a first barb 310. The first barb 310 is configured to abut against the hole wall of the second plug hole 140. In this manner, the engagement holder 300 is prevented from moving in a pluggable direction during the process of plugging and unplugging of the male connector 10, thereby improving the strength of the connection of the engagement holder 300 to the base 100 and reducing the probability of loosening of the engagement holder 300. In this embodiment, the first barb 310 is a protrusion, and the protrusion is barbed and bent toward the other end of the base 100. For example, the first barb 310 is an annular protrusion.

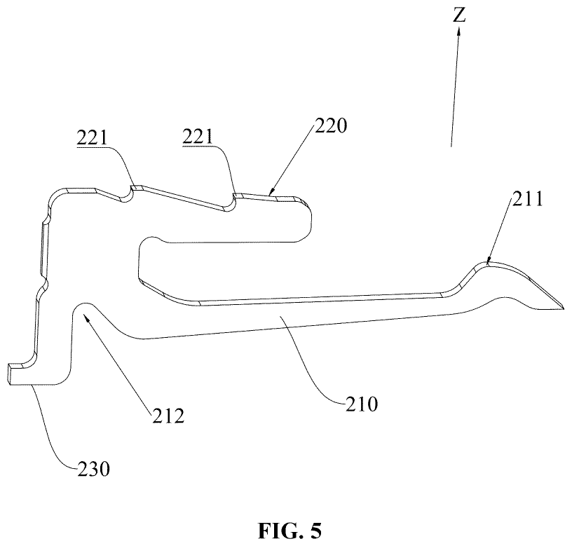

In this embodiment, as shown in FIG. 5, the limit structure 220 is provided with a second barb 221, and the second barb 221 is configured to abut against the slot wall of the auxiliary slot 130. In this manner, the limit structure 220 is prevented from moving in a pluggable direction during the process of plugging and unplugging of the male connector 10, thereby improving the strength of the connection of the limit structure 220 to the base 100 and reducing the probability of loosening of the limit structure 220. In this embodiment, the second barb 221 is a protrusion, and the protrusion is barbed and bent toward the other end of the base 100. For example, the second barb 221 is disposed on the side of the limit structure 220 facing away from the terminal body 210.

Optionally, as shown in FIG. 5, the other end of the terminal body 210 connected to the limit structure 220 is formed with a buffer slot 212. The buffer slot 212 is configured to enable one end of the terminal body 210 having the contact portion 211 to move in a second direction Z.

Thus, the terminal body 210 can elastically contact the male connector 10, thereby improving the adaptation capability of the conductive terminal 200. The second direction Z is perpendicular to the first direction X. In this embodiment, the first direction X is the width direction of the base 100, and the second direction Z is the height direction of the base 100.

Optionally, as shown in FIG. 2, multiple conductive terminals 200 are disposed. One plug slot 110 is disposed, and multiple first plug holes 120 are disposed in one-to-one correspondence with multiple auxiliary slots 130. A contact portions 211 at one end of each of multiple terminal bodies 210 is located in one plug slot 110 to be in electrical contact with the male connector 10 located in the plug slot 110. The multiple terminal bodies 210 are in one-to-one correspondence with the multiple first plug holes 120. Each terminal body 210 is configured to be plugged through the corresponding first plug hole 120, so that the multiple terminal bodies 210 can be independent of each other and cannot contact each other. Multiple limit structures 220 are in one-to-one correspondence with multiple auxiliary slots 130. Each limit structure 220 is limited in an auxiliary slot 130 corresponding to the limit structure 220. Thus, the auxiliary slot 130 can stop the limit structure 220 in each direction, thereby improving the stop effect of each limit structure 220.

For example, the conductive terminal 200 is an integrated structure, that is, the terminal body 210 and the limit structure 220 are an integrally formed structure and have high structural strength. Multiple auxiliary slots 130 are configured to avoid the electrical contact between limit structures 220, thereby avoiding the electrical contact between conductive terminals 200.

Further, optionally, multiple conductive terminals 200 are disposed in the first direction X at intervals. Each of the multiple auxiliary slots 130 and a respective one of the multiple first plug holes 120 are disposed in the second direction Z at intervals. Thus, the disposition of the auxiliary slots 130 does not affect the spacing between the conductive terminals 200, and the size of the female connector in the first direction X may be relatively small.

In this embodiment, the auxiliary slots 130 are disposed on a side of the plug slot 110 in a third direction Y. A first plug hole 120 is disposed under an auxiliary slot 130, so that the space on the base 100 can be fully utilized, thereby facilitating the miniaturization of the female connector. It is to be noted that the first direction X, the second direction Z, and the third direction

Y are perpendicular to each other. The third direction Y may be the length direction of the base 100.

Optionally, in the first direction X, two adjacent conductive terminals 200 have a space of 0.8 mm to 2 mm. For example, in the first direction X, two adjacent conductive terminals 200 have a space of 0.8 mm, 1 mm, 1.5 mm, or 2 mm. Preferably, in the first direction X, two adjacent conductive terminals 200 have a space of 1 mm.

Optionally, the base 100 has a length of 5 cm to 10 cm. For example, the base 100 has a length of 5 cm, 6 cm, and 10 cm. Preferably, the base 100 has a length of 6.55 cm. It is to be noted that the length direction of the base 100 is the third direction Y.

The base 100 has a width of 5.5 cm to 10 cm. For example, the base 100 has a width of 5 cm, 6 cm, and 10 cm. Preferably, the base 100 has a width of 6 cm. It is to be noted that the width direction of the base 100 is the first direction X.

The base 100 has a height of 2 cm to 5 cm. For example, the base 100 has a height of 5 cm, 6 cm, and 10 cm. Preferably, the base 100 has a height of 2.9 cm. It is to be noted that the height direction of the base 100 is the second direction Z.

In this embodiment, the plug slot 110 has a height of 1 cm to 2 cm. Preferably, the plug slot 110 has a height of 1.3 cm. The plug slot 110 has a height of 4 cm to 6 cm. Preferably, the plug slot 110 has a height of 4.5 cm.

An embodiment provides an electrical connector. The electrical connector includes the female connector as described above. The electrical connector provided by this embodiment has a relatively small overall volume and a relatively wide application range.

In some embodiments, the electrical connector is disposed on a circuit board 20. As shown in FIG. 4, a post 400 is disposed on the bottom of the base 100. The circuit board 20 is formed with a through hole. The post 400 passes through the through hole and is engaged onto the circuit board 20. The circuit board 20 is provided with a contact point. The conductive terminal 200 has a first connection end 230 located outside the base 100. The first connection end 230 is connected to the contact point on the circuit board 20. The engagement holder 300 has a second connection end 330 located outside the base 100. The second connection end 330 is connected to another contact point on the circuit board 20.

It is to be noted that the preceding are only preferred embodiments of the present application and technical principles used therein. It is to be understood by those skilled in the art that the present application is not limited to the embodiments described herein. Those skilled in the art can make various apparent modifications, adaptations and substitutions without departing from the scope of the present application. Therefore, while the present application is described in detail through the preceding embodiments, the present application is not limited to the preceding embodiments and may include more other equivalent embodiments without departing from the concept of the present application. The scope of the present application is determined by the scope of the appended claims.

What is claimed is:

1. A female connector, comprising:
a base formed with a plug slot, a first plug hole, and an auxiliary slot, wherein a male connector is configured to be plugged in the plug slot, and the first plug hole communicates with the plug slot and the auxiliary slot; and
a conductive terminal comprising a terminal body and a limit structure, wherein the terminal body is configured to be plugged through the first plug hole, one end of the terminal body has a contact portion located in the plug slot, another end of the terminal body is connected to the limit structure limited in the auxiliary slot.

2. The female connector according to claim 1, further comprising an engagement holder and a second hole formed in the base,
wherein one end of the engagement holder is limited in the second plug hole, and another end of the engagement holder is configured to engage and cooperate with the male connector.

3. The female connector according to claim 2, wherein the engagement holder is a grounding terminal.

4. The female connector according to claim 2, wherein,
two engagement holders and two second plug holes are correspondingly disposed, one end of each of the two engagement holders is limited in a respective second plug hole of the two second plug holes,
the base is formed with two receiving slots on opposite sides of the base in a first direction, the two engagement holders correspond to the two receiving slots in a one-to-one manner, and
another end of each engagement holder is configured to enter a respective receiving slot of the two receiving slots under compression of the male connector.

5. The female connector according to claim 2, wherein a portion of the engagement holder located in the second plug hole is provided with a first barb, and the first barb is configured to abut against a hole wall of the second plug hole.

6. The female connector according to claim 1, wherein the limit structure is provided with a second barb, and the second barb is configured to abut against a slot wall of the auxiliary slot.

7. The female connector according to claim 2, wherein the limit structure is provided with a second barb, and the second barb is configured to abut against a slot wall of the auxiliary slot.

8. The female connector according to claim 3, wherein the limit structure is provided with a second barb, and the second barb is configured to abut against a slot wall of the auxiliary slot.

9. The female connector according to claim 4, wherein the limit structure is provided with a second barb, and the second barb is configured to abut against a slot wall of the auxiliary slot.

10. The female connector according to claim 5, wherein the limit structure is provided with a second barb, and the second barb is configured to abut against a slot wall of the auxiliary slot.

11. The female connector according to claim 1, wherein the another end of the terminal body connected to the limit structure is formed with a buffer slot, and the buffer slot is configured to enable the one end of the terminal body having the contact portion to move in a second direction.

12. The female connector according to claim 2, wherein the another end of the terminal body connected to the limit structure is formed with a buffer slot, and the buffer slot is configured to enable the one end of the terminal body having the contact portion to move in a second direction.

13. The female connector according to claim 3, wherein the another end of the terminal body connected to the limit structure is formed with a buffer slot, and the buffer slot is configured to enable the one end of the terminal body having the contact portion to move in a second direction.

14. The female connector according to claim 4, wherein the another end of the terminal body connected to the limit structure is formed with a buffer slot, and the buffer slot is configured to enable the one end of the terminal body having the contact portion to move in a second direction.

15. The female connector according to claim 5, wherein the another end of the terminal body connected to the limit structure is formed with a buffer slot, and the buffer slot is configured to enable the one end of the terminal body having the contact portion to move in a second direction.

16. The female connector according to claim 1, wherein,
a plurality of conductive terminals, one plug slot, a plurality of first plug holes, a plurality of auxiliary slots, a plurality of terminal bodies, and a plurality of limit structures are provided,
the plurality of first plug holes are disposed in one-to-one correspondence with a plurality of the plurality of auxiliary slots,
a contact portion at one end of each of the plurality of terminal bodies is located in the one plug slot,
the plurality of terminal bodies are plugged through the plurality of first plug holes in a one-to-one manner, and
the plurality of limit structures are limited in the plurality of auxiliary slots in a one-to-one manner.

17. The female connector according to claim 2, wherein,
a plurality of conductive terminals, one plug slot, a plurality of first plug holes, a plurality of auxiliary slots, a plurality of terminal bodies, and a plurality of limit structures are provided,
the plurality of first plug holes are disposed in one-to-one correspondence with a plurality of the plurality of auxiliary slots,
a contact portion at one end of each of the plurality of terminal bodies is located in the one plug slot,
the plurality of terminal bodies are plugged through the plurality of first plug holes in a one-to-one manner, and
the plurality of limit structures are limited in the plurality of auxiliary slots in a one-to-one manner.

18. The female connector according to claim 16, wherein,
the plurality of conductive terminals are disposed in a first direction at intervals,
each of the plurality of auxiliary slots and a respective one of the plurality of plug holes are disposed in a second direction at intervals,
the plurality of auxiliary slots are disposed on a side of the plug slot in a third direction,
wherein the first direction, the second direction, and the third direction are perpendicular to each other.

19. The female connector according to claim 18, wherein in the first direction,
two adjacent conductive terminals of the plurality of conductive terminals have a space of 0.8 mm to 2 mm; and
the base has a length of 5 cm to 10 cm, a width of 5.5 cm to 10 cm, and a height of 2 cm to 5 cm.

20. An electrical connector, comprising a female connector, wherein the female connector comprises:
a base formed with a plug slot, a first plug hole, and an auxiliary slot, wherein a male connector is 5 configured to be plugged in the plug slot, and the first plug hole communicates with the plug slot and the auxiliary slot; and
a conductive terminal comprising a terminal body and a limit structure, wherein the terminal body is configured to be plugged through the first plug hole, one end of the terminal body has a contact portion located in the plug slot, another end of the terminal body is connected to the limit structure limited in the auxiliary slot.
